(19) United States
(12) Patent Application Publication
(10) Pub. No.: US 2004/0250663 A1
(43) Pub. Date: Dec. 16, 2004

(54) Handle structure for hand tool

(76) Inventor: Chih-Ching Hsien, Taichung (TW)

Correspondence Address: Chih-Ching Hsien, 58, MA YUAN WEST ST., TAICHUNG, TW

(21) Appl. No.: 10/463,066

(22) Filed: Jun. 13, 2003

(51) Int. Cl. B25B 7/00

(52) U.S. Cl. 81/427.5

(57) ABSTRACT

A handle structure for a hand tool includes a handle portion having a top face integrally formed with an upper auxiliary body and a bottom face integrally formed with a lower auxiliary body. Thus, the upper auxiliary body and the lower auxiliary body forming a larger force bearing region to increase the force bearing area of the handle portion, thereby facilitating a user's hand holding the handle portion.

### BACKGROUND OF THE INVENTION

1. Field of the Invention

The present invention relates to a handle structure for a hand tool, such as a pair of pliers or the like, and more particularly to a handle structure having a larger force bearing area, thereby facilitating the user's hand holding the handle portion.

2. Description of the Related Art

A conventional hand tool, such as a pair of pliers or the like, in accordance with the prior art shown in FIGS. 8 and 9 comprises two half portions 30 pivotally combined with each other by a pivot member 33. Each of the two half portions 30 has a first end formed with a jaw portion 31 and a second end formed with a handle portion 32. Each of the two half portions 30 has a plastic jacket 34 mounted on the handle portion 32.

However, the handle portion 32 has a circular cross-section as shown in FIG. 9, so that the outer side of the handle portion 32 has a smaller force bearing area. Thus, when the user's hand exerts a larger force on the handle portion 32, the user's hand easily feels uncomfortable due to the smaller force bearing area provided by the handle portion 32, thereby causing inconvenience to the user's hand when holding the handle portion.

### SUMMARY OF THE INVENTION

The primary objective of the present invention is to provide a handle structure for a hand tool, wherein the upper auxiliary body, the lower auxiliary body and the arcuate convex face form a larger force bearing region to increase the force bearing area of the handle portion, thereby facilitating the user's hand holding the handle portion.

Another objective of the present invention is to provide a handle structure for a hand tool, wherein the protective jacket has a configuration matching that of the handle portion, so that the protective jacket encompasses the periphery of the handle portion closely so as to provide a comfortable sensation to the user, thereby facilitating the user's hand holding the handle portion.

A further objective of the present invention is to provide a handle structure for a hand tool, wherein the auxiliary rib is connected to the upper auxiliary body and the lower auxiliary body so as to reinforce the strength of the handle portion.

In accordance with the present invention, there is provided a handle structure for a hand tool, comprising:

a handle portion having a top face integrally formed with an upper auxiliary body and a bottom face integrally formed with a lower auxiliary body;

the upper auxiliary body and the lower auxiliary body forming a large force bearing region to increase a force bearing area of the handle portion, thereby facilitating a user's hand holding the handle portion.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool in accordance with the preferred embodiment of the present invention;

FIG. 2 is a perspective view of the hand tool in accordance with the preferred embodiment of the present invention;

FIG. 3 is a side plan cross-sectional view of the hand tool as shown in FIG. 1;

FIG. 4 is a side plan cross-sectional view of the hand tool as shown in FIG. 2;

FIG. 5 is a top plan view of a hand tool in accordance with another embodiment of the present invention;

FIG. 6 is a side plan cross-sectional view of the hand tool as shown in FIG. 5;

FIG. 7 is a perspective view of a hand tool in accordance with another embodiment of the present invention;

FIG. 8 is a perspective view of a conventional hand tool in accordance with the prior art; and

FIG. 9 is a side plan cross-sectional view of the conventional hand tool as shown in FIG. 8.

### DETAILED DESCRIPTION OF THE INVENTION

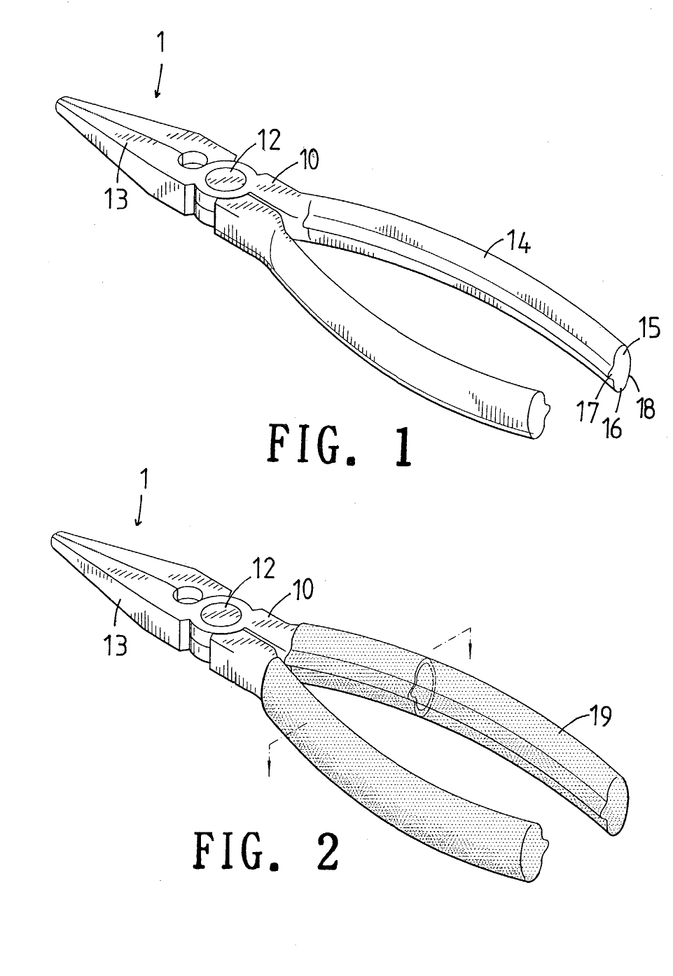

Referring to the drawings and initially to FIGS. 1-4, a hand tool 1, such as a pair of pliers or the like, in accordance with the preferred embodiment of the present invention comprises two half portions 10 pivotally combined with each other by a pivot member 12. Each of the two half portions 10 has a first end formed with a jaw portion 13 and a second end formed with a handle portion 14.

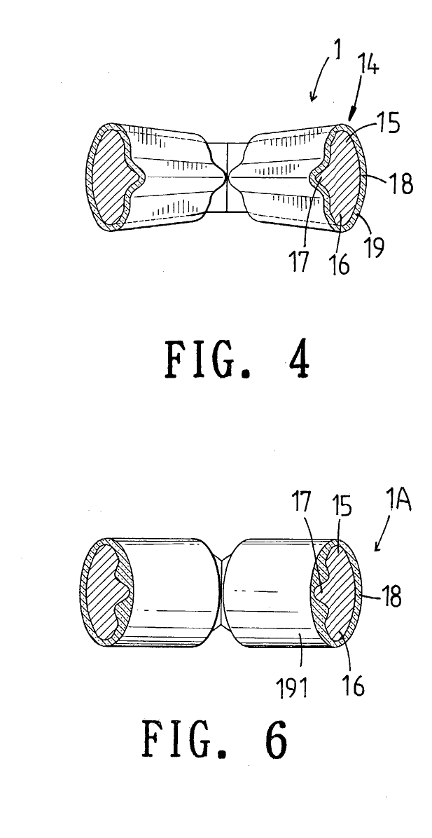

The handle portion 14 has a top face integrally formed with an upper auxiliary body 15 and a bottom face integrally formed with a lower auxiliary body 16. Preferably, the upper auxiliary body 15 protrudes outward from the top face of the handle portion 14, and the lower auxiliary body 16 protrudes outward from the bottom face of the handle portion 14. Preferably, the handle portion 14 has a cross section having an elongated thin shape. Thus, the width of the cross section of the handle portion 14 is greater than the thickness of the cross section of the handle portion 14 as shown in FIG. 4.

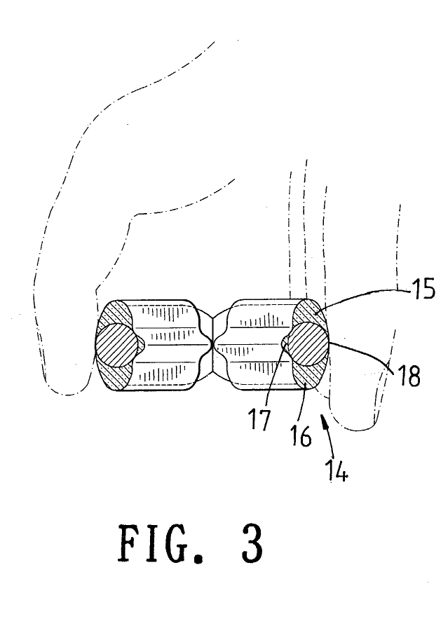

As shown in FIGS. 3 and 4, the upper auxiliary body 15 and the lower auxiliary body 16 form a larger force bearing region to increase the force bearing area of the handle portion 14, thereby facilitating the user's hand holding the handle portion 14.

The handle portion 14 has an outer side integrally formed with an arcuate convex face 18 which forms a larger force bearing region to increase the force bearing area of the handle portion 14, thereby facilitating the user's hand holding the handle portion 14.

The handle portion 14 has an inner side integrally formed with an auxiliary rib 17 connected with the upper auxiliary body 15 and the lower auxiliary body 16 so as to reinforce the strength of the handle portion 14. Preferably, the auxiliary rib 17 protrudes outward from the inner side of the handle portion 14.

Each of the two half portions 10 has a soft protective jacket 19 mounted on a periphery of the handle portion 14 to provide a comfortable sensation to the user, thereby facilitating the user's hand holding the handle portion 14. Preferably, the protective jacket 19 has a configuration matching that of the upper auxiliary body 15, the lower auxiliary body 16, the auxiliary rib 17 and the arcuate convex face 18 as shown in FIG. 4, so that the protective jacket 19 has a configuration matching that of the handle portion 14.

Accordingly, the upper auxiliary body 15, the lower auxiliary body 16 and the arcuate convex face 18 form a larger force bearing region to increase the force bearing area of the handle portion 14, thereby facilitating the user's hand holding the handle portion 14. In addition, the protective jacket 19 has a configuration matching that of the handle portion 14, so that the protective jacket 19 closely encompasses the periphery of the handle portion 14 so as to provide a comfortable sensation to the user, thereby facilitating the user's hand holding the handle portion 14. Further, the auxiliary rib 17 is connected to the upper auxiliary body 15 and the lower auxiliary body 16 so as to reinforce the strength of the handle portion 14.

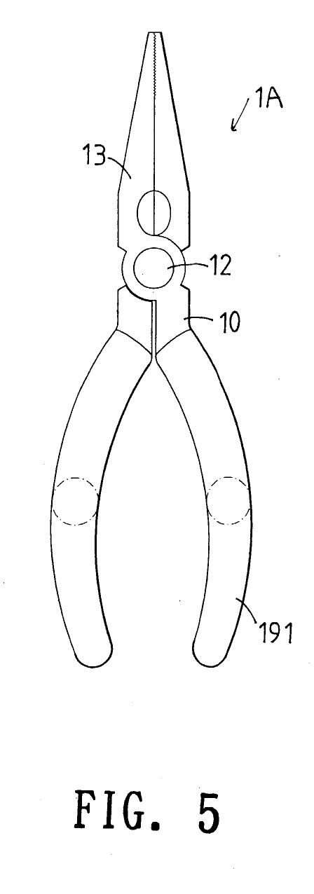

Referring to FIGS. 5 and 6, a hand tool 1A in accordance with another preferred embodiment of the present invention is shown, wherein the soft protective jacket 191 has an inner portion having a configuration matching that of the upper auxiliary body 15, the lower auxiliary body 16, the auxiliary rib 17 and the arcuate convex face 18 and has an outer portion having an oblong configuration as shown in FIG. 6.

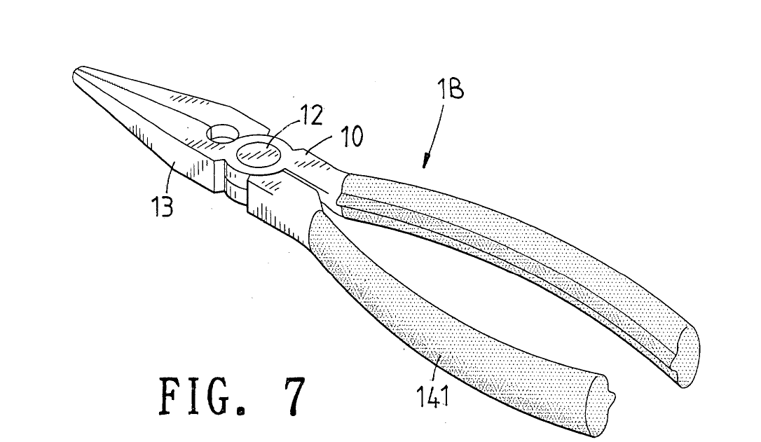

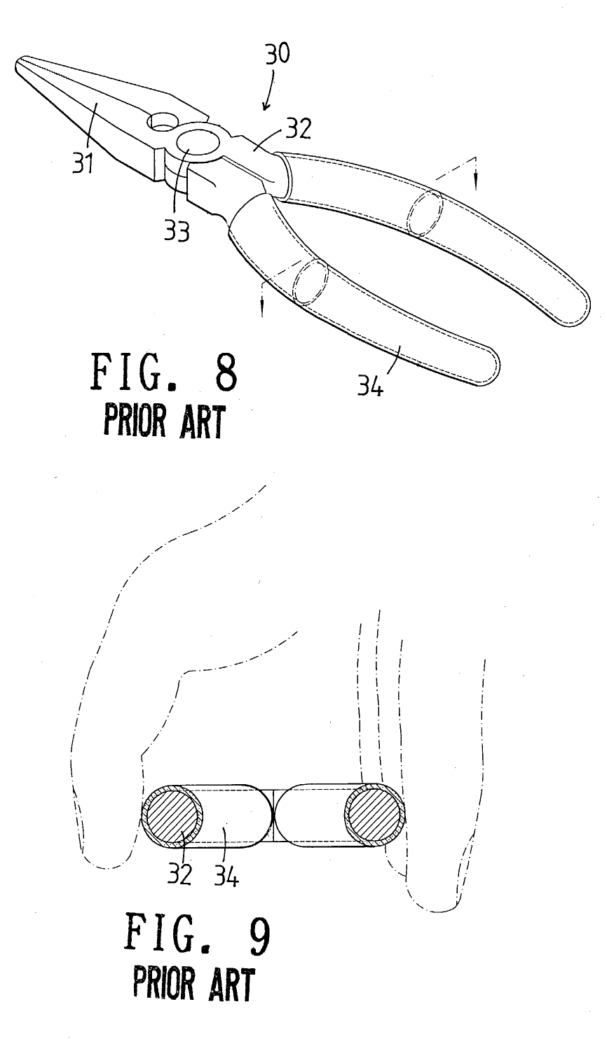

Referring to FIG. 7, a hand tool 1B in accordance with another preferred embodiment of the present invention is shown, wherein the handle portion 141 has a size gradually reduced from a front end to a rear end thereof.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A handle structure for a hand tool, comprising:
a handle portion having a top face integrally formed with an upper auxiliary body and a bottom face integrally formed with a lower auxiliary body;
the upper auxiliary body and the lower auxiliary body forming a large force bearing region to increase a force bearing area of the handle portion, thereby facilitating a user's hand holding the handle portion.

2. The handle structure for a hand tool in accordance with claim 1, wherein the upper auxiliary body protrudes outward from the top face of the handle portion.

3. The handle structure for a hand tool in accordance with claim 1, wherein the lower auxiliary body protrudes outward from the bottom face of the handle portion.

4. The handle structure for a hand tool in accordance with claim 1, wherein the handle portion has a cross section having an elongated thin shape.

5. The handle structure for a hand tool in accordance with claim 4, wherein the width of the cross section of the handle portion is greater than the thickness of the cross section of the handle portion.

6. The handle structure for a hand tool in accordance with claim 1, wherein the handle portion has an outer side integrally formed with an arcuate convex face which forms a large force bearing region to increase the force bearing area of the handle portion.

7. The handle structure for a hand tool in accordance with claim 1, wherein the handle portion has an inner side integrally formed with an auxiliary rib connected with the upper auxiliary body and the lower auxiliary body.

8. The handle structure for a hand tool in accordance with claim 7, wherein the auxiliary rib protrudes outward from the inner side of the handle portion.

9. The handle structure for a hand tool in accordance with claim 1, further comprising a soft protective jacket mounted on a periphery of the handle portion.

10. The handle structure for a hand tool in accordance with claim 9, wherein the protective jacket has a configuration matching that of the handle portion.

11. The handle structure for a hand tool in accordance with claim 9, wherein the protective jacket has a configuration matching that of the upper auxiliary body and the lower auxiliary body.

12. The handle structure for a hand tool in accordance with claim 9, wherein the handle portion has an inner side integrally formed with an auxiliary rib connected with the upper auxiliary body and the lower auxiliary body, and the protective jacket has a configuration matching that of the auxiliary rib.

13. The handle structure for a hand tool in accordance with claim 9, wherein the handle portion has an outer side integrally formed with an arcuate convex face, and the protective jacket has a configuration matching that of the arcuate convex face.

14. The handle structure for a hand tool in accordance with claim 9, wherein the soft protective jacket has an inner portion having a configuration matching that of the handle portion and has an outer portion having an oblong configuration.

15. The handle structure for a hand tool in accordance with claim 1, wherein the handle portion has a size gradually reduced from a front end to a rear end thereof.
